(19) United States
(12) Patent Application Publication
(10) Pub. No.: US 2009/0071733 A1
(43) Pub. Date: Mar. 19, 2009

(54) Hybrid electric vehicle

(76) Inventors: Zhihui Duan, Ann Arbor, MI (US); Ling Ling Zhang, Ann Arbor, MI (US)

Correspondence Address: Ling Ling Zhang, 3012 Gallinger Dr., Ann Arbor, MI, 48103, US

(21) Appl. No.: 11/901,503

(22) Filed: Sep. 18, 2007

(51) Int. Cl. B60K 6/36; B60K 6/42; B60W 10/08

(52) U.S. Cl. 180/65.21; 903/909

(57) ABSTRACT

A full hybrid electric vehicle comprises a heat engine, a one-way-clutch connected to the engine shaft, an electric motor, a planetary gear unit, a clutch with limited torque, and a transmission. The planetary gear unit includes at least a sun gear (an input element), a ring gear (an input element) and a pinion carrier (an output element). The torque-limited clutch seats between two of the planetary gear elements. The engine is connected to and applies torque on one of the input elements. The electric motor is connected to and applies torque on the other input element. While the vehicle is running, the engine can be started smoothly by engaging the torque-limited clutch and controlling the motor torque, and a shock on the vehicle similar to a rough shift can be avoided.

### FEDERALLY SPONSORED RESEARCH

Not Applicable

### SEQUENCE LIST OR PROGRAM

Not Applicable

### TECHNICAL FIELD

This invention relates to hybrid electric vehicle. More particularly, this invention relates to a hybrid electric vehicle with a planetary gear unit.

### BACKGROUND OF THE INVENTION

The purpose of a hybrid-electric vehicle (HEV) transmission is to provide a neutral, at least one reverse and one or more forward driving ranges that impart power from an engine, and/or from one or more electric machines, to the drive shaft which delivers torque to the driving wheels.

There are different types of hybrid electric vehicles.

In a so-called series hybrid electric vehicle, an engine drives an electric generator, and an electric motor uses the electricity and drives the wheels. All the engine power is delivered to the wheels electrically. There is no mechanical connection between the engine and the drive wheels, so a series hybrid vehicle needs two sets of large electric machines and control modules to deliver all the engine power to the wheels. Also, there is a certain amount of energy loss during each conversion, so an electric transmission has lower energy efficiency than a mechanical transmission does.

In a so-called parallel hybrid electric vehicle, both the engine and the motor(s) drives the wheels directly through mechanical drive train. All the engine power can be delivered to the wheels mechanically. A parallel HEV is the most energy efficient, and it is flexible for the motor and control module capacity.

A so-called power split hybrid electric vehicle is between the series and the parallel HEV. It employs one or more planetary gear sets to couple the engine torque with the motor torque(s), and it delivers one portion of engine power to the wheels mechanically and delivers the other portion to the wheels electrically. The portion of the engine power electrically delivered is converted into electric power and then converted back into mechanical one. There is a certain amount of energy loss during each conversion, so the fuel efficiency of a power split HEV is not as high as that of a parallel HEV. A power split HEV has two large electric machines.

U.S. Pat. No. 6,953,409 proposes a so-called two-mode HEV to improve the fuel efficiency and to downsize the motors by adding two more planetary gear units and some clutches, but it still needs two powerful electric machines.

U.S. Pat. No. 6,569,054 proposes a parallel hybrid electric vehicle. It includes an engine, an electric machine having both functions of a generator and a motor, a transmission, a planetary gear mechanism combining the engine torque and the motor torque, an electromagnetic two-way clutch selectively controlling engaging and disengaging between respective elements of the planetary gear mechanism. It is a parallel HEV and has only one electric machine. The HEV has a major weakness: it can not start the engine when the vehicle is running, so it can not provide the electric drive mode, unless another motor is added to start the engine while the vehicle is running.

The electric drive mode is of driving the vehicle with the electric machine(s) while the engine is off. It is a very fuel efficient feature for city driving, and, in fact, it differentiate “full hybrid electric vehicles” from other HEV, like “mild HEV”.

A “full hybrid electric vehicle” has the abilities of: shutting down the engine when the vehicle stops, driving the vehicle solely on electrical power up to a certain speed, starting the engine when the vehicle is running, regenerating electricity while braking; and assisting the engine with electric power when needed.

The purpose of this invention is to provide a parallel hybrid electric vehicle which has only one electric machine and has the abilities of a full hybrid electric vehicle.

### SUMMARY OF THE INVENTION

A hybrid electric vehicle according to the present invention has an internal combustion engine, a one-way clutch (OWC), an electric machine, a planetary gear unit, a clutching mechanism with limited torque, and a transmission for changing the speed ratio and the direction.

The one-way clutch is mounted to the engine shaft, allowing the engine to rotate forwards freely and preventing the engine from rotating backward in the electric drive mode.

The planetary gear unit has at least a sun gear, a carrier with planet gears (pinions), and a ring gear. The sun gear and the ring gear are the input elements. The sun gear is connected to the motor and the ring gear is connected to the engine shaft. The carrier is the output element and is connected to the input shaft of the transmission. The planetary gear unit is to combine the torques of the engine and the motor.

The transmission has one input shaft and one output shaft, and it can change the speed ratio of the output shaft to the input shaft. It also can change the rotating direction of the output shaft.

The clutching mechanism applies a limited torque and allows relative rotation between the two shafts when it is engaged. Any kind of torque coupling mechanisms can be used if only it allows sliding and applies limited or controlled torque between the two shafts. Some examples are a wet sliding clutch, a torque controllable electromagnetic clutch, and a hydraulic torque converter plus a lock clutch.

The motor is to drive the vehicle in electric drive mode, to start the engine when the vehicle is at a standstill or is running, to assist the engine to drive the vehicle, and to re-generate electric energy during braking.

The torque-limited clutch is disengaged when it is in electric drive mode and when the vehicle is at very low speed; it is engaged to start the engine and to lock the planetary gear unit when the engine is driving with/without motor's assistance. Since the torque between the sun gear and the ring is limited, the engine can be started smoothly without applying torque shock on the drive shaft.

The hybrid electric vehicle is a “full hybrid electric vehicle” and has the abilities of: shutting down the engine when the vehicle stops, driving the vehicle solely on electrical power up to a certain speed, starting the engine while the vehicle is running, regenerating electricity while braking; and assisting the engine with electric power when needed.

### BRIEF DESCRIPTION OF THE DRAWINGS

FIG. 1 shows the schematic view of a hybrid all-wheel drive system according to the present invention.

FIG. 2 is a velocity line diagram depicting the interrelationship among the sun gear speed (n_{S}), the ring gear speed (n_{R}), and the carrier speed (n_{C}) according to the present invention.

FIG. 3 is a torque line diagram depicting the interrelationship among the sun gear torque (T_{S}), the ring gear torque (T_{R}), and the carrier torque (T_{C}) according to the present invention.

FIG. 4 is a velocity line diagram depicting the sun gear speed (n_{S}), the ring gear speed (n_{R}), and the carrier speed (n_{C}) when the motor 5 starts the engine 1 and then generates electricity while vehicle is at a standstill according to the present invention.

FIG. 5 is a velocity line diagram depicting the speeds of the sun gear S, the Ring gear R, and the carrier C when the vehicle is accelerated from zero speed while the engine is running.

FIG. 6 is a velocity line diagram depicting the procedure of the engine 1 and the motor 5 are locked together and then drive the vehicle in parallel while the vehicle is running according to the present invention.

FIG. 7 is a velocity line diagram depicting the speeds of the sun gear S, the Ring gear R, and the carrier C when the motor 5 drives and accelerates the vehicle while the engine 5 is off according to the present invention.

FIG. 8 is a velocity line diagram depicting the speeds of the sun gear S, the Ring gear R, and the carrier C during the procedure of starting the engine 1 while the vehicle is running according to the present invention.

FIG. 9 is a diagram depicting the torques and the angular accelerations of the sun gear S, the Ring gear R, and the carrier C during the procedure of starting the engine 1 while the vehicle is running according to the present invention.

### DETAILED DESCRIPTION OF THE PREFERRED EMBODIMENTS

For the sake of convenience of description, if an engine shaft is connected to a mechanical component, it is simply said as that the engine is connected to the component; if a motor rotor shaft is connected to a mechanical component, it is simply said as that the motor is connected to the component.

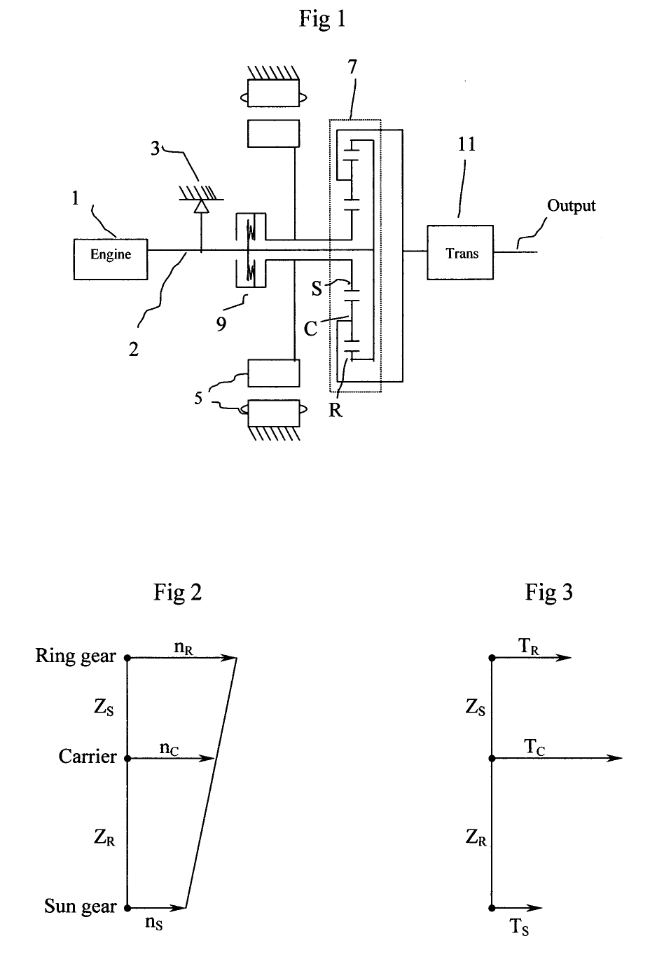

FIG. 1 shows the schematic view of a hybrid electric vehicle according to the present invention. It comprises: an internal combustion engine 1 with an output shaft 2; a one-way clutch 3, a motor 5, a planetary gear unit 7, a clutch 9 with limited torque, and a transmission 11.

The planetary gear unit 7 is to combine the torque of the engine 1 with the torque of the motor 5 and comprises at least three elements: a sun gear S, a ring gear R, and a planet pinion carrier C. The sun gear S is an input element and connected to the motor 5. The ring gear R is another input element and connected to the engine shaft 2. The carrier C is the output element and is connected to the input shaft of the transmission 11.

The engine 1 converts the fuel energy into mechanical energy and, through its shaft 2, applies a torque on the ring gear R.

The one-way clutch 3 is attached to the engine shaft 2. It allows the engine 1 to rotate forward but prevents the engine 1 from rotating backward. It applies and exerts a reaction torque on the ring gear R in the electric drive mode. The electric drive mode is the mode that the motor 5 drives the vehicle while the engine 5 is off.

The motor 5 is connected to the sun gear S. The motor 5 applies a drive torque on the sun gear S to drive the vehicle solely or assist the engine 1 in driving. It applies a torque to start the engine 1 when the vehicle either is at a standstill or is running. It can also apply a braking torque on the sun gear S during braking and, at the same time, recover the kinetic energy of the vehicle into electric energy for a battery (not shown) to store. The torque and speed of the motor 5 are controllable.

The clutch 9 has a pre-set limited or controllable torque and is to engage and disengage the sun gear S and the ring gear R. When disengaged, it allows a free relative rotation between the two elements; when engaged, it applies only a limited torque between the two elements, smoothing the shock on the shafts due to the different speeds. Although it is called the clutch 9 thereafter, many kinds of clutching mechanisms can be used if only it allows relative rotation and applies limited or controllable torque between the two elements when engaged. Some examples are a wet sliding clutch, a torque-controllable electromagnetic clutch, and a hydraulic torque converter plus a lock clutch.

Transmission 11 has an input shaft and an output shaft. It can change the speed ratio of the output to the input and it can change the output direction.

FIG. 2 shows the relationship among the sun gear speed (n_{S}), the ring gear speed (n_{R}), and the carrier speed (n_{C}), wherein Z_{S} and Z_{R} are the numbers of cogs of the sun gear S and the ring gear R, respectively. The arrows point out the forward rotary direction of the three elements, respectively. When any two of the speeds are known, the third speed is determined and can be calculated by using the following equation:

n_{S}·Z_{S}+n_{R}·Z_{R}=n_{C}·(Z_{S}+Z_{R}) (1)

FIG. 3 shows the torque on the sun gear S (T_{S}), the torque on the ring gear R (T_{R}), and the torque on the carrier C (T_{C}), wherein Z_{S} and Z_{R} are the numbers of cogs of the sun gear S and the ring gear R, respectively. The arrows point out the forward torque direction of the three elements, respectively. When any one of the torques is known, the other two are determined and can be calculated with:

$${T}_{C} = {T}_{S} + {T}_{R} \\ \frac{{T}_{S}}{{Z}_{S}} = \frac{{T}_{R}}{{Z}_{R}} \qquad ( 2 )$$

### Operation

According to the present invention, the hybrid-electric vehicle is able to: start the engine 1 smoothly when the vehicle is either at a standstill or running, accelerate the vehicle from zero speed when the engine is either on or off, drive the vehicle with the engine 1 and the motor 5 in parallel, and apply regenerative braking.

To Start the Engine while the Vehicle is at a Standstill:

When the vehicle is at a standstill, either the parking mechanism or the brake is applied, so the carrier C is hold at zero speed. To start the engine 1, the motor 5 applies backward torque on the sun gear S, and the sun gear S begins to speed up backwards; since the carrier C is hold at zero speed, the ring gear R and, therefore, the engine 1 are forced to rotate forwards; when it reaches its idle speed, the engine 5 starts.

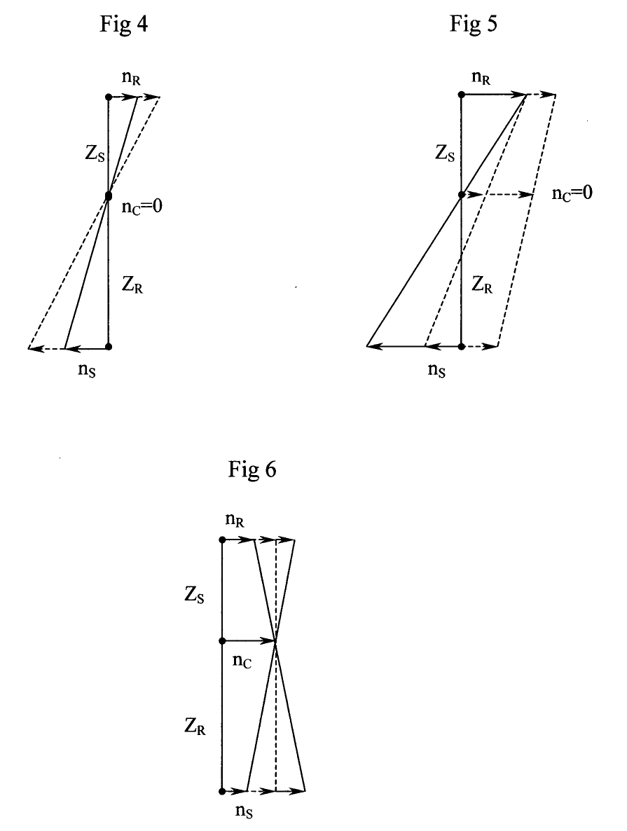

FIG. 4 shows the speeds of the three elements during the procedure of starting the engine 5.

To Generate Electricity while the Vehicle Stands Still

When the vehicle is at a standstill, either the parking mechanism or the brake is applied, so the carrier C is hold at zero speed. For the motor 5 to generate electricity, the engine 1 runs forwards and applies forward torque on the ring gear R; since the carrier C is hold at zero speed, the sun gear S and the motor 5 are forced to rotate backwards, and the motor 5 generates electricity using the torque from the sun gear S.

The speeds of the three elements in this situation are shown as the dash lines in FIG. 4.

To Accelerate the Vehicle from Zero Speed while the Engine is Running:

When the vehicle is at standstill, the engine 1 and the ring gear R are running forwards, the sun gear S is running backwards, and the carrier C has a zero speed. The speeds of the three elements are as the solid lines in FIG. 5.

To pull out the vehicle from standstill, the engine 1 applies a torque T_{R} on the ring gear R and the motor 5 applies a torque T_{S} on the sun gear S; according to Equation (2), a torque T_{C} will be applied on the carrier C, the carrier C will pass on the torque T_{C} through the transmission 11 to the wheels; and the wheels will drive the vehicle; when the vehicle is speeded up, the speed of the carrier C increases, so do the speeds of the sun gear S and the ring gear R, as shown as the dash lines in FIG. 5.

The engine 1 and the motor 5 can increase their speeds evenly, and therefore the carrier C can increase its speed evenly, so the vehicle can launch very smoothly. Neither a launch clutch nor a torque converter is necessary.

To Drive the Vehicle with the Engine and Motor in Parallel:

When the carrier C reaches the engine idle speed (the corresponding vehicle speed could be below 5 miles per hour) or higher, the clutch 9 may be engaged. When clutch 9 is engaged, the planetary gear unit is locked together, so all three elements will run at the same speed, and so the engine 1 and the motor 5 can drive the vehicle in parallel. FIG. 6 shows the speeds of the three elements before (by solid lines) and after (by dash lines) the engagement.

In this mode, the engine 1 drives the wheels directly. Engaged with the engine shaft 2, the motor 5 may either work as a motor to drive the vehicle or as a generator to generate electricity or run at idle.

When it is necessary and before the battery is fully discharged or fully charged, the clutch 9 may stay disengaged, allowing the engine 1 to work at its most efficient speed, even though the carrier C has a speed above the engine idle speed.

To Shift Gear:

In order to shift gear, the transmission 11 gets out of the current gear; then the motor 5 changes its speed to adjust the speed of the carrier C, and the carrier C speed is so adjusted that the transmission input speed is aligned to the speed for the next gear; and then the transmission 11 selects the next gear. Since the two shafts have the same speed before the gear is selected, the shift is smooth.

During gear shifting, the clutch 9 may be either engaged or disengaged. In either situation, the motor can adjust the carrier C speed to the alignment speed for the next gear, based on Equation (1). If it is engaged, all the three elements have the same speed; if it is disengaged, the elements may have different speed. In either situation, Equation (1) set the rule for the speeds of the three elements.

It is assumed that the engine speed signal and the vehicle speed signal are available. The speed of the transmission output can be calculated based on the vehicle speed and the gear ratio.

To Apply Regenerative Braking:

When the clutch 9 is engaged, the regenerative braking works in the same way as a parallel hybrid electric vehicle. When brake is applied, the engine 1 is running idle or turned off; the motor 5 applies a backward torque on the sun gear S and work as a generator; since the planetary gear unit is locked together, the backward torque will be applied on the carrier C; the carrier C outputs a braking torque which tends to slow down the vehicle. When the motor 5 applies braking torque, it can convert the vehicle's kinetic energy into electric energy for the battery to store. The engine 1 also applies backward torque due to the pumping and friction resistance.

When the clutch 9 is disengaged, the regenerative braking works in this way: when brake is applied, the engine 1 is running idle or turned off; the motor 5 applies a backward torque on the sun gear S and work as a generator; the planetary pinions tend to speed up the engine 1; under the pumping and the friction resistance, the engine 1 will apply backward torque on the ring gear R; according to Equation (2), the backward torques from the engine 1 and the motor 5 are applied on the carrier C; the carrier C outputs a backward torque which tends to slow down the vehicle. When the motor applies braking torque, it can convert the vehicle's kinetic energy into electric energy for the battery to store.

When the vehicle comes to a stop or low speed, the engine 1 will shut down. The engine 1 may stay running if the vehicle needs electric power either to recharge the battery or power things like an air conditioner.

For the Electric Motor to Drive the Vehicle while the Engine is Off:

In this mode, the engine 1 is off, and the transmission is either set to “Drive” or “Reverse”; the motor 5 runs forwards at speed of n_{S} and applies a drive torque T_{S} on the sun gear S. The sun gear S applies forces on the planet pinions, and the pinions tend to turn the ring gear R backwards. Being connected to the engine shaft 2, the ring gear R tends to turn the engine 1 backwards. On the other hand, the one-way clutch 3 does not allow the engine 1 to turn backwards and will apply a reaction torque T_{R} on the ring gear R. According to Equation (1) and (2), the carrier C will output a drive torque T_{C}=T_{S}+T_{R}=T_{S}*(Z_{S}+Z_{R})/Z_{S} while rotating at a speed of n_{C}=n_{S}*Z_{S}(Z_{S}+Z_{R}). The transmission 11 will pass on the drive torque and speed to the wheels.

The transmission 11 can change the speed ratio and direction, so the motor 5 can drive the vehicle either forwards or reverse.

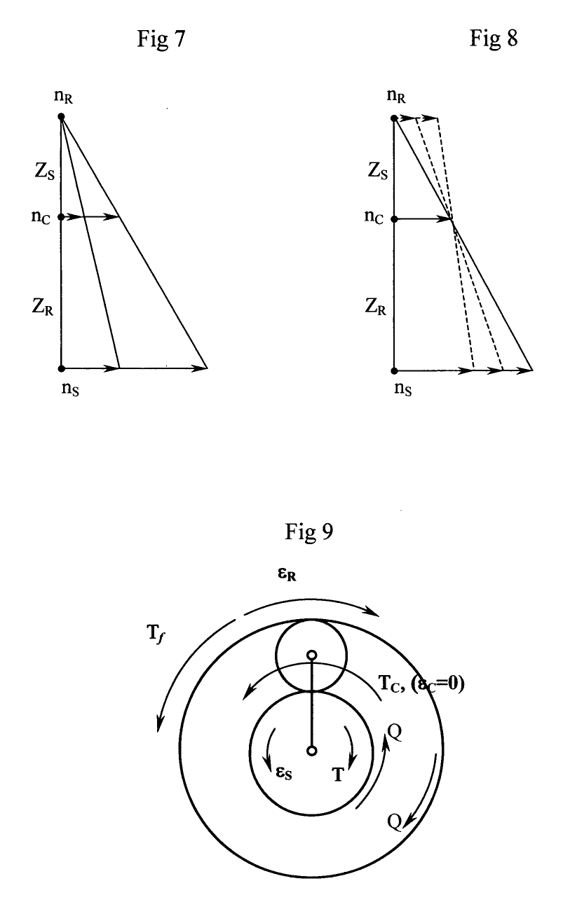

FIG. 7 shows the speeds of the sun gear S, the ring gear R, and the carrier C. In this situation, the engine 1 does not run, so n_{R} is zero.

To Start the Engine while the Vehicle is Running:

Before the process of starting engine, the engine is at zero speed and the speeds of the three elements of the planetary gear unit are shown as solid lines in FIG. 8. In order to start the engine, the clutch 9 is engaged and, at the same time, the motor 5 applies a certain torque on the sun gear S; when the clutch 9 is engaged, it will apply a forward torque on the ring gear R, tending to turn the engine 1 forward; when it reaches its idle speed, the engine 1 starts.

FIG. 8 shows the speeds of the three elements before (in solid lines) and during (in dash lines) the procedure of the starting engine while the vehicle is running.

It is understood that the engine shaft 2 has its angular inertia and it has a zero speed before the clutch 9 is engaged. When the three elements with different speeds are locked together, it behaves like a fully-inelastic angular collision and tends to apply a torque impulse on each element, and the magnitude of the clutching torque of the clutch 9 determines the magnitude of the torque impulse on each element. The torque impulse on the carrier C will result in a strong shock on the vehicle and make the people in the vehicle feel very uncomfortable, especially if the torque impulse is negative. So a strong and/or negative torque impulse on the carrier is not acceptable.

This problem is solved by significantly reducing the magnitude of the impulse and ensuring that no negative torque is applied on the carrier C through the following three ways:

### 1. Reduce the Torque Impulse on the Carrier C Due to the Angular Inertia of the Engine Shaft 2.

The engine shaft 2 may result in a negative torque impulse on the carrier C when the clutch 9 is engaged because the speed of the engine shaft 2 is lower than that of the carrier C.

This torque impulse could be partially or totally offset by the angular momentum of the motor 5. According to FIG. 8, the speed of the sun gear S is higher than that of the carrier C, so when the clutch 9 is engaged, the sun gear S tends to apply a positive torque impulse on the carrier C. The positive torque impulse will offset the same amount of the negative torque impulse.

Suppose the sun gear S has a speed n_{S}, the ring gear R has a speed n_{R}, and the carrier has a speed n_{C} before the clutch 9 is engaged, then the total angular momentum of the system is

L₀=ω_{S}*J_{S}+ω_{R}*J_{R}+ω_{C}*J_{C} (3)

where ω_{S} and J_{S} are the (angular) speed and the angular inertia of the sun gear S and the motor 5, respectively; ω_{R} and J_{R} are the (angular) speed and the angular inertia of the ring gear R and the engine shaft 2, respectively; and ω_{C} and J_{C} are the (angular) speed of the carrier C and the angular inertia on the carrier C, respectively. Equation (1) governs the relation among the speeds of the three elements of the planetary gear unit.

If we design the planetary gear unit and the motor 5 in such way that the ratio of the angular inertia J_{S} to the cog number Z_{S} of the sun gear S is equal to the ratio of the angular inertia J_{R} to the cog number Z_{R} of the ring gear R, or

J_{S}/Z_{S}=J_{R}/Z_{R} (4)

then, substituting Equation (1) into Equation (3), we will have:

L₀=ω_{S}*J_{S}+ω_{R}*J_{R}+ω_{C}*J_{C}=ω_{C}*(J_{S}+J_{R}+J_{C}) (5)

When the three elements are locked together, they will all run at a certain speed ω₁, and the total angular momentum of the system is:

L₁=ω₁*(J_{S}+J_{R}+J_{C}) (6)

Since it takes a very short time for the clutch 9 to be engaged, the external torque can have very little impact on the total angular momentum, so the external torque can be ignored for the analysis. According to the law of conservation of angular momentum, the angular momentum of the system before the engagement is equal to that after the engagement, so we have:

L₀=ω_{C}*(J_{S}+J_{R}+J_{C})=L₁=ω₁*(J_{S}+J_{R}+J_{C})

and then:

ω₁=ω_{C} (7)

So the speed of the carrier C will not change during the engagement of the clutch 9. In another ward, the torque impulse on the carrier C due to the angular inertia of the engine shaft 2 can be eliminated by designing the system so that J_{S}/Z_{S}=J_{R}/Z_{R}.

For the analysis above, there is no limitation on the clutching torque of the clutch 9, so the conclusion is true even if the clutching torque is infinite in theory.

It would be difficult to keep Equation (4) exactly valid in the real world, but the torque impulse on the carrier C due to the angular inertia of the engine shaft 2 can be significantly reduced by designing the system so that J_{S}/Z_{S} is as close to J_{R}/Z_{R} as possible.

### 2. Limit the Clutching Torque of the Clutch 9:

Each element has its own angular inertia, and before the engagement, they run at different speeds. When the clutch 9 engages the sun gear S to the ring gear R, it tends to lock the three elements together. It is a fully-inelastic angular collision of the three elements, and the clutching torque of the clutch 9 determines the magnitude of the torque impulse between the two elements. In theory, if the clutch torque is infinite, the magnitude of the torque impulse will be infinite. Realistically, a clutch without torque limitation will cause a very strong torque impulse which will result in strong shock on the vehicle.

In the hybrid electric vehicle according to the present invention, the clutching torque is limited to a certain value, so the peak value of the torque impulse is under control. The clutch 9 is a clutching mechanism that, when engaged, allows relative rotation and applies only a limited torque between the two elements. Since the clutching torque has a limited value, the torque to hold the three elements together is limited and under control, and so the torque on the carrier C during the engagement is also limited and under control.

### 3. Control the Motor Torque in an Range:

If the angular inertia of the motor 5 is not enough to offset the angular inertia of the engine shaft 2, a certain negative torque will be applied on the carrier C when the clutch 9 is engaged. It is the impact of the engine shaft 2 at low speed on the carrier 2. A negative torque is not acceptable because it will cause a deceleration while the operator is trying to accelerate the vehicle.

Since the clutch 9 applies a preset limited torque, the negative torque on the carrier C is limited, so a certain positive torque could cancel out it. The motor 5 can apply a drive (positive) torque on the sun gear S and cancel out the negative torque.

In order to cancel out the negative torque, the motor 5 must apply large enough torque. On the other hand, the motor torque tends to drive the planetary pinions forwards, and the pinions tend to drive the ring gear backwards. If the drive torque is too strong, the engine 1 can not be speeded up. So the motor torque have to be controlled in a certain range.

FIG. 9 shows the torques and angular accelerations on the planetary gear unit 7: T is the motor torque, ε_{S} is the acceleration of the sun gear S, T_{f} is the friction torque of the engine 1, ε_{R} is the acceleration of the ring gear R, and Q is the torque of the clutch 9 applied between the ring gear R and the sun gear S. The vehicle inertia is much larger than either the engine inertia or the motor inertia, so the acceleration of the carrier shaft is considered as zero (so ε_{S}*Z_{S}=ε_{R}*Z_{R}) and it is substituted with a reaction torque T_{C} to the carrier C. We can have two dynamic equations for the system as follows:

$$\begin{matrix}{ɛ}_{R} = \frac{{Z}_{R} \cdot {Z}_{S}}{{J}_{S} \cdot {Z}_{R}^{2} + {J}_{R} \cdot {Z}_{S}^{2}} \cdot ( \frac{{Z}_{R} + {Z}_{S}}{{Z}_{R}} \cdot Q - T - \frac{{Z}_{S}}{{Z}_{R}} \cdot {T}_{f} ) & ( 8 ) \\ {T}_{C} = T + {ɛ}_{R} \cdot ( \frac{{Z}_{R}}{{Z}_{S}} \cdot {J}_{S} - {J}_{R} ) - {T}_{f} & ( 9 )\end{matrix}$$

In order to start the engine 5 in a short time, ε_{R} must be large enough; in order to start the engine smoothly, T_{C} must not be negative. According to Equation (8) and (9), a large clutching torque Q has positive impact on the acceleration and a negative impact on the smoothness; a large drive torque T has a negative impact on the acceleration and a positive impact on the smoothness; as it is expected, if J_{S}/Z_{S}=J_{R}/Z_{R}, then there is no torque impulse on the carrier C during the engagement, and the closer the J_{S}/Z_{S} value is to the J_{R}/Z_{R} value, the smaller the torque impulse is applied on the carrier C.

Assuming T_{f}=35 Nm, Q=140 Nm, Z_{S}=30, Z_{R}=78, J_{S}=0.02 kg-m², and J_{R}=0.14 kg-m²:
if T=80 Nm, then ε_{R}=270 rad/sec² and T_{C}=21 Nm, and
if T=70 Nm, then ε_{R}=297 rad/sec² and T_{C}=8.9 Nm.

In each situation, the engine 1 can be accelerated from zero to 800 rpm (Revolutions per minute) in about 0.3 second, and no negative torque is applied on the transmission input. At around 800 rpm, the engine 1 can start smoothly. The process of starting the engine takes less than one half second, the engine 1 starts smoothly, and the transmission output stays positive. So its impact on the vehicle is equivalent to or better than a manual gear shifting.

For those being knowledgeable in the field, it is obvious that one element of the planetary gear unit 7 may exchange its connection with another element and the system will work in a similar way.

It should be understood that there is no intention to limit the invention to the specific forms disclosed, but on the contrary, the invention is to cover all variations, modifications and improvements that come with the true spirit and scope of the invention as expressed in the appended claims.

What is claimed is:

1. A hybrid electric vehicle comprising:
a heat engine outputting power through an engine shaft;
a one-way-clutch being connected to said engine shaft to keep said engine shaft from turning backwards;
an electric motor for outputting a torque through a motor shaft and for generating electric power;
a transmission for providing at least one reverse speed and one or more forward speeds;
a planetary gear unit comprising at least three gear elements which are a first gear element connected to said engine shaft, a second gear element connected to said motor shaft, and a third gear element connected to said transmission; and
a clutching mechanism for selectively providing a limited torque between said first gear element and said second gear element;
wherein, while the vehicle is running, said clutching mechanism is engaged and applies a limited torque between said first gear element and second gear element and said electric motor applies a controllable torque on said second gear element, so that said engine can be started smoothly and neither a torque impulse nor a negative torque is outputted to said transmission.

2. A hybrid vehicle according to claim 1 wherein said clutching mechanism is between any two of the three gear elements.

3. A hybrid vehicle according to claim 1 wherein said transmission is a manual transmission.

4. A hybrid vehicle according to claim 1 wherein said transmission is an automatic transmission.

5. A hybrid vehicle according to claim 1 wherein said transmission is a continuously variable transmission.
